(19) United States
(12) Patent Application Publication
(10) Pub. No.: US 2014/0104082 A1
(43) Pub. Date: Apr. 17, 2014

(54) INFORMATION DISPLAY DEVICE

(71) Applicants: Shusuke Nakamura, Tokyo (JP); Mitsuo Shimotani, Tokyo (JP); Hiroaki Sugino, Tokyo (JP)

(72) Inventors: Shusuke Nakamura, Tokyo (JP); Mitsuo Shimotani, Tokyo (JP); Hiroaki Sugino, Tokyo (JP)

(73) Assignee: MITSUBISHI ELECTRIC CORPORATION, Tokyo (JP)

(21) Appl. No.: 14/124,201

(22) PCT Filed: Sep. 20, 2011
(86) PCT No.: PCT/JP2011/005284

§ 371 Date: Dec. 5, 2013

(51) Int. Cl. G06F 1/32

(52) U.S. Cl. CPC G06F 1/3265; G06F 1/3212
USPC 340/995.15; 340/438

(57) ABSTRACT

In an information display device having a display screen and driven by receiving power supply from a battery, there is provided with a plurality of display patterns each of which the display range is reduced from a full screen display state displayed on the whole of the display screen, and the screen is switched to any one of the plurality of display patterns in accordance with a battery remaining capacity and a display content, and displayed.

### TECHNICAL FIELD

The present invention relates to an information display device that is driven by receiving power supply from a battery in a battery driven vehicle (moving body), or a portable terminal activated by a battery, or the like.

### BACKGROUND ART

In recent years, an environmentally-friendly battery driven vehicle (moving body) such as a hybrid car, and a portable terminal activated by the battery such as a PC, a portable telephone, and a music player have been increasing. However, these are advanced in multi-functionality, and battery consumption in functions other than a main function is increased, and hence service life of the battery becomes shorter.

These vehicle (moving body), portable terminal, and the like each include a display device driven by receiving power supply from the battery; if the battery consumption by the display device can be reduced, the service life of the battery is increased, and the increased life can be applied to the main function.

For example, Patent Document 1 discloses the following display device: a battery level is monitored, backlights of the display device are controlled in accordance with the level, and brightness, contrast, and display resolution thereof, and ON/OFF of the display device are changed to thus maintain visibility thereof while achieving an energy saving thereof. In addition, Patent Document 2 discloses the following battery remaining capacity display device: a battery remaining capacity display unit is turned off if a battery capacity is larger than a constant value and also a vehicle speed of an electric vehicle and so on are constant or more, and the display unit is turned on otherwise; in contrast, if the battery capacity is the constant value or less, the display unit is always turned on so as to urge charging thereof.

### PRIOR ART DOCUMENTS

### Patent Documents

Patent Document 1: Japanese Patent Application Laid-open No. 2000-75963

Patent Document 2: Japanese Patent Application Laid-open No. H10-20004

### SUMMARY IN THE INVENTION

### Problems to be Solved by the Invention

However, the foregoing conventional devices merely perform control of the backlights of the display device or performs ON/OFF control thereof in accordance with the battery capacity; a display content displayed on a display screen thereof at the moment, and/or an operation mode in the corresponding device (e.g., an operation mode such that the vehicle (moving body) such as a hybrid car is traveling in an electric travel (EV travel) mode, an operation mode such that the portable terminal is running in a power saving mode, etc.) are not considered at all. Therefore, there is a problem such that the battery consumption cannot be effectively reduced while a display of information necessary for a user is maintained.

The present invention is made to solve the foregoing problem, and an object of the invention is to provide an information display device capable of reducing effectively the battery consumption by the screen display while maintaining the display of the information necessary for the user.

### Means for Solving the Problems

In order to achieve the aforementioned object, the present invention provides an information display device having a display screen and driven by receiving power supply from a battery, characterized in that there is provided with a plurality of display patterns each of which the display range is reduced from a full screen display state displayed on the whole of the display screen, and that if a battery remaining capacity is a predetermined value or less, the screen is switched to any one of the plurality of display patterns in accordance with a display content displayed on the display screen, and displayed.

### Effect of the Invention

According to the information display device of the present invention, since it is configured that the display range is switched to any one of the plurality of display patterns each of which the display range is reduced in accordance with the battery remaining capacity and the display content, and displayed, battery consumption by the screen display can be effectively reduced while a display of information necessary for a user is maintained, and thus the service life of the battery is increased, and the increased life can be applied to a main function.

### BRIEF DESCRIPTION OF THE DRAWINGS

FIG. 1 is a block diagram of an information display device in a hybrid car according to Embodiment 1 of the present invention.

FIG. 2 is a table showing an operation mode of the hybrid car according to Embodiment 1 of the invention.

FIG. 3 is a flowchart showing processes related to a display screen of the information display device in the hybrid car according to Embodiment 1 of the invention.

FIG. 4 is a table showing an example of operation modes and predetermined modes.

FIG. 5 is an illustration showing an example of display patterns (display range reduction patterns) of the screen.

FIG. 6 is an enlarged detailed view showing an example of a reduction of an illumination area of backlights.

### BEST MODE FOR CARRYING OUT THE INVENTION

In the following, embodiments of the present invention will be described in detail with reference to the accompanying drawings.

### Embodiment 1

In Embodiment 1 of the present invention, an information display device that is driven by receiving power supply from a battery in a vehicle (moving body) such as a hybrid car will be described.

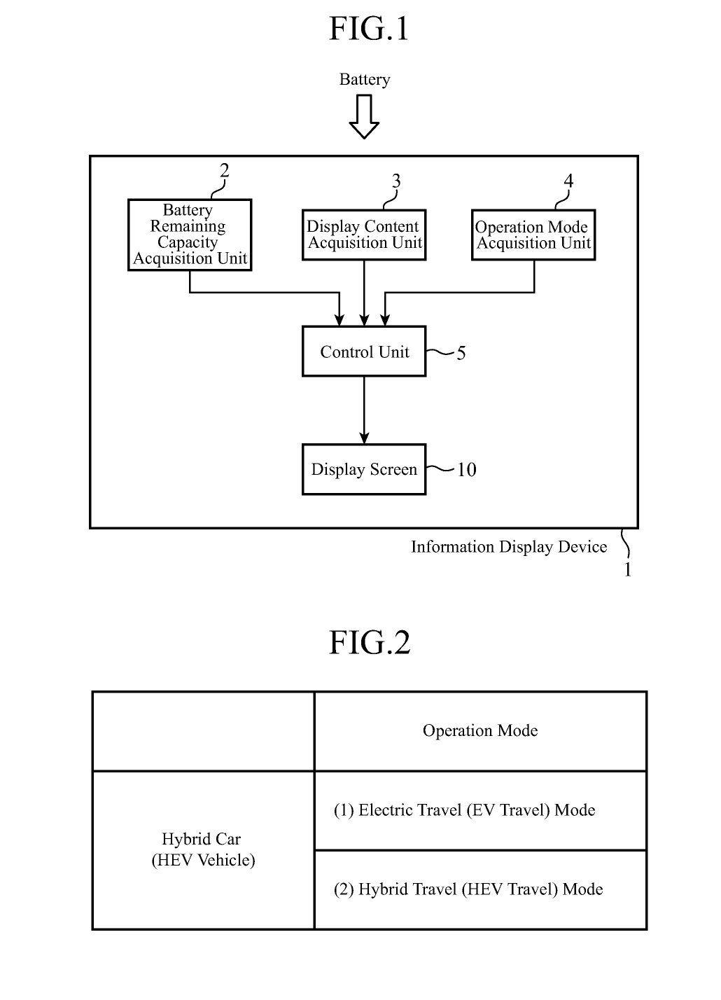

FIG. 1 is a block diagram of an information display device 1 in a hybrid car according to Embodiment of the invention. It is configured that the information display device 1 is driven by receiving power supply from a battery mounted on the hybrid car, and includes a display screen 10, a battery remaining capacity acquisition unit 2 for acquiring a battery remaining capacity, a display content acquisition unit 3 for acquiring a content displayed on the display screen 10, an operation mode acquisition unit 4 for acquiring an operation mode of the hybrid car, and a control unit. Then, the control unit 5 controls a display range displayed on the display screen 10, and an illumination area or illumination intensity of backlights provided on a back side of the display screen 10, on the basis of the battery remaining capacity acquired by the battery remaining capacity acquisition unit 2, the display content acquired by the display content acquisition unit 3, and the operation mode acquired by the operation mode acquisition unit 4.

Note that the battery and the information display device 1 are provided in the vehicle (moving body).

FIG. 2 is a table showing the operation mode of the hybrid car according to Embodiment 1 of the invention. In the case of a hybrid car, an operation mode includes an electric travel (EV travel) mode that travels by only the power of a motor by a battery, and a hybrid travel (HEV travel) mode that travels by both powers of an engine and the motor. Then, in the present invention, the display screen is switched to one of display patterns each reduced in the display range in accordance with the battery remaining capacity and the display content, or in accordance with the battery remaining capacity, and the operation mode and display content.

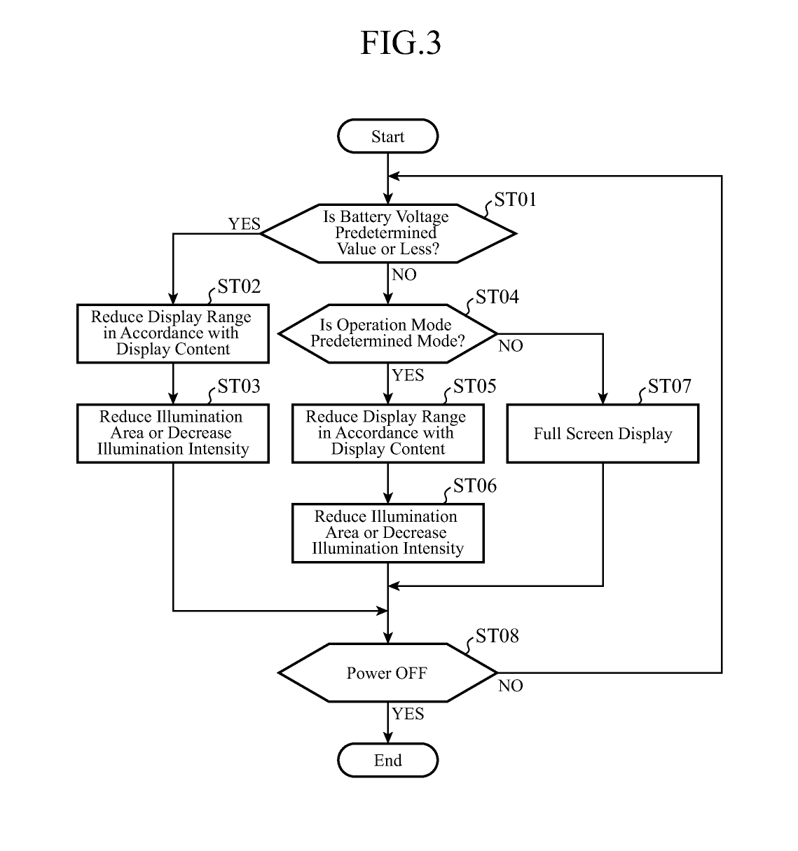

FIG. 3 is a flowchart showing processes related to the display screen 10 of the information display device 1 in the hybrid car according to Embodiment 1 of the invention. A process of acquiring a battery voltage (battery remaining capacity) with the battery remaining capacity acquisition unit 2, a process of acquiring the display content displayed on the display screen 10 with the display content acquisition unit 3, and a process of acquiring the operation mode of the hybrid car with the operation mode acquisition unit 4 are not shown in the flowchart; however, on the assumption that these processes are being executed, the following process will be described: the control unit 5 controls a process of controlling the display range displayed on the display screen 10, and the illumination area and/or the illumination intensity of the backlights on the basis of the above battery remaining capacity, display content, and operation mode.

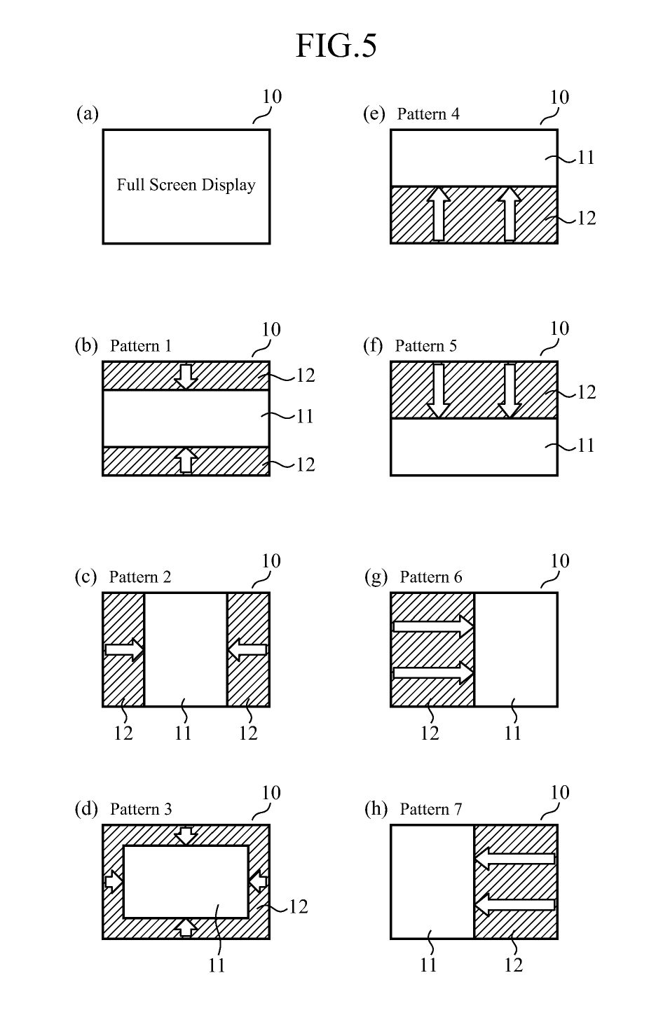

First of all, if a battery voltage (battery remaining capacity) acquired by the battery remaining capacity acquisition unit 2 is a predetermined value or less (YES in Step ST01), the display range of the screen is reduced in accordance with the display content acquired by the display content acquisition unit 3 regardless of the operation mode (Step ST02), and further the illumination area of the backlights is reduced or the illumination intensity thereof is decreased with the reduction in the display range (Step ST03). In these steps, a description will be given later with reference to FIG. 5 of how the display range is reduced in accordance with the display content.

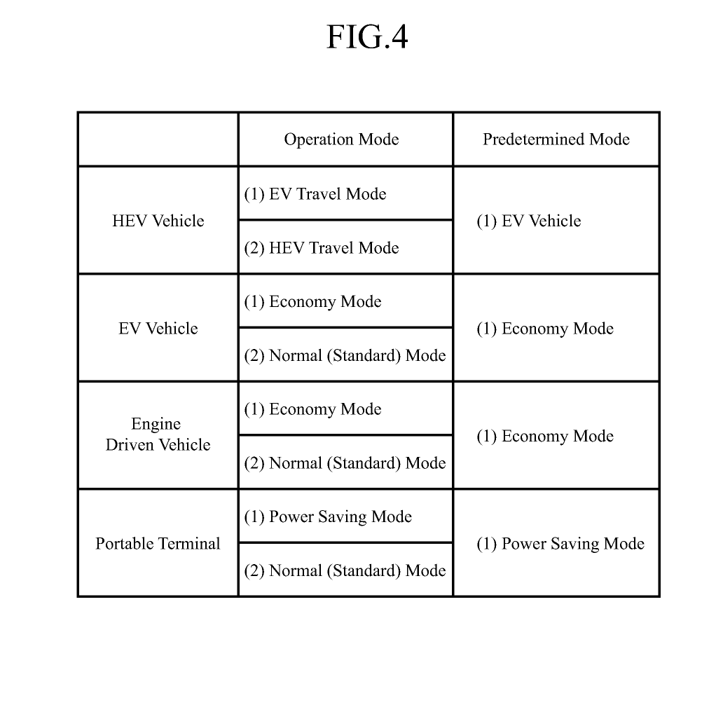

In contrast, if the battery voltage (battery remaining capacity) is larger than the predetermined value (NO in Step ST01), it is determined whether or not the operation mode acquired by the operation mode acquisition unit 4 is a predetermined mode; if it is the predetermined mode (YES in Step ST04), the display range of the screen is reduced in accordance with the display content acquired by the display content acquisition unit 3 (Step ST05), and further, the illumination area of the backlights is reduced or the illumination intensity thereof is decreased with the reduction in the display range (Step ST06). In these steps, the operation mode and the predetermined mode will be described later with reference to FIG. 4. Also, a description will be given later with reference to FIG. 5 of how the display range is reduced in accordance with the operation mode and display content.

On the other hand, if the battery voltage (battery remaining capacity) is larger than the predetermined value, and the operation mode acquired by the operation mode acquisition unit 4 is not the predetermined mode (NO in Step ST04), a full screen display that is displayed on the whole of the display screen 10 is performed (Step ST07). Then, when the above determinations are repeatedly controlled till power of the information display device 1 is turned off (YES in Step ST08), battery consumption by the screen display can be reduced.

Here, the “predetermined mode” of the operation mode will be described. In the case of the hybrid car (HEV vehicle) as described in Embodiment 1, the operation mode includes the EV travel mode and the HEV travel mode as shown in FIG. 2, and the “predetermined mode” in the above is the EV travel mode.

FIG. 4 is a table showing an example of the operation modes and the predetermined modes including Embodiment 1 and other cases. As shown in FIG. 4, examples of the “predetermined mode” in the other cases, namely cases of the other vehicles (moving bodies) and/or a portable terminal, include: for example, an economy mode (eco-mode) (a mode that adjusts drive of a motor to extend a travel distance) in an electric car (EV vehicle); an economy mode (a mode of laying stress on a mileage that travels while controlling the engine speed lower than that of a usual case) in an engine driven vehicle; a power saving mode (a mode where the backlights are turned off when not used) in the portable terminal; and so on.

Next, a description will be given of how the display range is reduced in accordance with the display content, or in accordance with the operation mode and display content.

FIG. 5 is an illustration showing an example of display patterns (display range reduction patterns) of the screen: only in FIG. 5(a), the display range of the display screen 10 is not reduced, that is, there is shown a display area in a full screen display state to be displayed on the whole of the display screen 10. Then, the display patterns (pattern 1 to pattern 7) shown in FIG. 5(b) to FIG. 5(h) are the following plurality of display patterns: if the battery voltage (battery remaining capacity) is the predetermined value or less, or if the battery voltage (battery remaining capacity) is larger than the predetermined value and the operation mode is the predetermined mode, the display range is reduced from the full screen display state shown in FIG. 5(a) according to the display content displayed on the display screen 10 at that moment, and displayed. It is noted that an arrow in the figures shows a direction to be reduced from the state of FIG. 5(a).

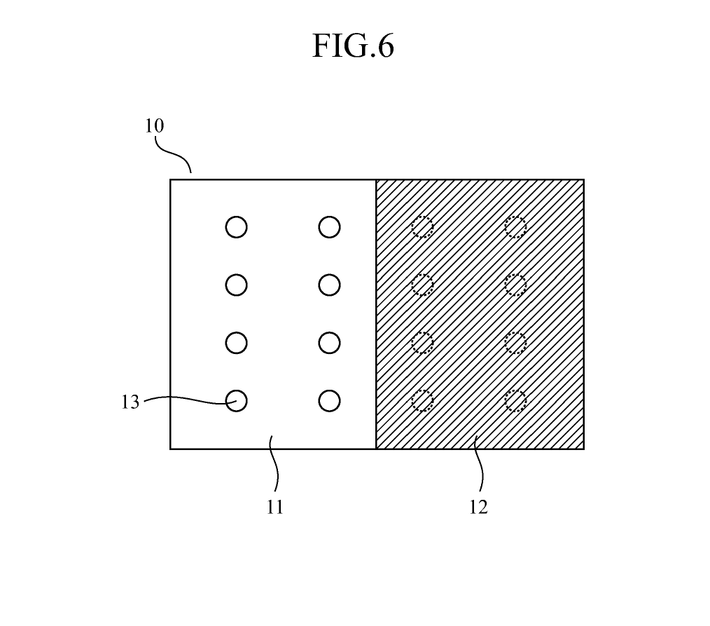

For example, in the hybrid car, in the case where the battery voltage (battery remaining capacity) is larger than the predetermined value, the operation mode is the hybrid travel (HEV travel) mode, a screen of a navigation system is displayed in north-up display as the display content displayed on the display screen 10; at this time, in the case where the operation mode is transferred to the electric travel (EV travel) mode during the guide display, when the vehicle is traveling in the east-west direction, the pattern 1 in which the display range is reduced such that only a central portion of the screen that is horizontally elongated as shown in FIG. 5(b) becomes a display range 11 is selected, and displayed. In contrast, when the vehicle is traveling in the north-south direction, the pattern 2 in which the display range is reduced such that only a central portion of the screen that is vertically elongated as shown in FIG. 5(c) becomes the display range 11 is selected, and displayed. In such a way, it is possible to reduce the battery consumption while maintaining display of information necessary for a user. Note that the reduction in the illumination area and the decrease in the illumination intensity of the backlights will be described later with reference to FIG. 6.

In contrast, in the case where the battery voltage (battery remaining capacity) is the predetermined value or less, when the screen of the navigation system is displayed in north-up display as the display content displayed on the display screen 10; at this time, in a similar manner, the pattern 1 or pattern 2 as shown in FIG. 5(b) or FIG. 5(c) is selected, and displayed.

Further, as another example of the display content displayed on the display screen 10, for example, in the hybrid car, in the case where the battery voltage (battery remaining capacity) is larger than the predetermined value, the display content displayed on the display screen 10 is an image (video) display or a moving image (picture) reproduction; at this time, if the operation mode is transferred from the HEV travel mode to the EV travel mode, the pattern 3 in which the display range 11 is entirely reduced in the middle while maintaining the same aspect ratio as that of the full screen display state as shown in FIG. 5(d) is selected, and displayed. In such a way, it is possible to lower the resolution while performing the image display or moving image reproduction without impairing the aspect ratio, and therefore it is possible to lessen display processing, and decrease the illumination intensity of the backlights, thereby reducing the battery consumption.

Also, in the case where the battery voltage (battery remaining capacity) is the predetermined value or less, when the display content displayed on the display screen 10 is the image display or moving image reproduction; at this time, in a similar manner, the pattern 3 as shown in FIG. 5(d) is selected, and displayed.

Similarly, in the case where the battery voltage (battery remaining capacity) is the predetermined value or less, or in the case where the battery voltage (battery remaining capacity) is larger than the predetermined value, and the operation mode is the predetermined mode, it is assumed that the screen is set to be switched to any one of the following plurality of display patterns in accordance with the display content displayed on the display screen 10 at that moment, and displayed: for example, if the information necessary for the user is located on the upper half of the display screen 10, the screen is switched to the pattern 4 as shown in FIG. 5(e), and displayed; if the necessary information is located on the lower half thereof, the screen is switched to the pattern 5 as shown in FIG. 5(f), and displayed; if the necessary information is located on the right half thereof, the screen is switched to the pattern 6 as shown in FIG. 5(g), and displayed; if the necessary information is located on the left half thereof, the screen is switched to the pattern 7 as shown in FIG. 5(h), and displayed; and so on.

Note that in the above, the description is given of the case where the operation mode of the hybrid car is the EV travel mode (predetermined mode); however, as shown in FIG. 4 mentioned previously, as in the case of the other vehicles or the portable terminal, if the battery voltage (battery remaining capacity) is larger than the predetermined value, the screen has only to be switched to any one of the plurality of display patterns in accordance with each operation mode and each display content displayed on the display screen, and displayed.

FIG. 6 is an enlarged detailed view showing an example of a reduction of an illumination area of backlights 13. As mentioned previously, in the case where the battery voltage (battery remaining capacity) is the predetermined value or less, or in the case where the battery voltage (battery remaining capacity) is larger than the predetermined value and the operation mode is the predetermined mode, it is assumed that the display range is reduced like the pattern 7 shown in FIG. 5(h), for example. At this time, a state where the illumination area of the backlights 13 is reduced to only the left of the screen that is the display range 11 is the one shown in FIG. 6. Also, it may be contemplated that the illumination intensity of the backlights 13 is decreased instead of the reduction of the illumination area of the backlights 13. In this case, the illumination intensity of the backlights 13 may be reduced to only the right of the screen that is assigned to a non-display range 12 with reduction in the display range, or the illumination intensity of the backlights 13 in both of the display range 11 and the non-display range 12 may be reduced.

Regarding a reduction method of the illumination area of the backlights, the illumination intensity of the backlights in each of the display range and the non-display range is controlled and decreased in such a manner that the illumination area is divided into a plurality of areas, and controlled in accordance with the display range reduction pattern. As a range of the illumination intensity to be decreased, the battery consumption can be further reduced when the illumination intensity not only in the non-display range but also in the display range is lowered. In contrast, in the case where the control is performed without the division into the display range and the non-display range, when the illumination intensity is totally reduced, the battery consumption can be reduced.

Thus, the information display device according to Embodiment 1 of the present invention has the plurality of display patterns, reduces the display range of the screen by switching the display patterns in accordance with the display content when the battery remaining capacity reaches the predetermined value or less, and further reduces the illumination area of the backlights or decreases the illumination intensity thereof with the reduction of the display range. In addition, even in the case where the battery remaining capacity is larger than the predetermined value, when the operation mode is the predetermined mode, the information display device reduces the display range of the screen by switching the display patterns in accordance with the display content, and further reduces the illumination area of the backlights or decreases the illumination intensity thereof with the reduction of the display range.

The performance of such control can reduce effectively the battery consumption of the screen display while the display of the information necessary for the user is maintained.

As described above, according to Embodiment 1 of the present invention, since it is configured that the display range is switched to any one of the plurality of display patterns each of which the display range is reduced in accordance with the battery remaining capacity and the display content, or the battery remaining capacity, and the operation mode and display content, and displayed, the battery consumption by the screen display can be effectively reduced while the display of the information necessary for the user is maintained, and the service life of the battery is increased, and the increased life can be applied to a main function.

### Embodiment 2

In Embodiment 1, the description is given for the information display device of the hybrid car; however, the information display device of the present invention is not limited to the vehicle (moving body), but it is applicable to a device having any form as long as the device has a display screen and is driven by receiving power supply from a battery, including a portable terminal such as a PC, a portable telephone, and a music player.

Therefore, in Embodiment 2, an information display device in the portable terminal will be described in place of the hybrid car in Embodiment 1.

In this case, the portable terminal is an information display device 1 itself including a display screen, and hence an operation mode acquired by an operation mode acquisition unit 4 of the information display device 1 is an operation mode of the information display device 1 itself. That is, in the case of the portable terminal, as shown in FIG. 4, the operation mode includes a power saving mode (mode where backlights are turned off when not used), and a normal (standard) mode, and these are the same as the operation modes of the information display device 1. For this reason, in Embodiment 2, the operation mode acquisition unit 4 of the information display device 1 is only different from that of Embodiment 1 in that the operation mode acquisition unit 4 acquires the operation mode of the information display device 1 itself, and the other processes are the same, and thus descriptions and illustrations thereof will be omitted.

Further, in the case of Embodiment 2, similarly to Embodiment 1, when a display range is switched to any one of a plurality of display patterns each of which the display range is reduced in accordance with a battery remaining capacity and a display content, or the battery remaining capacity and the operation mode and display content, and displayed, battery consumption by a screen display can be effectively reduced while the display of information necessary for a user is maintained, and further the service life of a battery is increased, and the increased life can be applied to a main function.

It is noted that the present invention can be implemented by a free combination of the embodiments, a modification of arbitrary components of the embodiments, or an omission of arbitrary components of the embodiments within the scope of the invention.

### INDUSTRIAL APPLICABILITY

The information display device of the present invention is applicable to the vehicle (moving body) such as the hybrid car, or the portable terminal such as the PC, portable telephone, and music player.

### EXPLANATION OF REFERENCE NUMERALS/SYMBOLS

1 information display device, 2 battery remaining capacity acquisition unit, 3 display content acquisition unit, 4 operation mode acquisition unit, 5 control unit, 10 display screen, 11 display range, 12 non-display range, 13 backlight.

1-4. (canceled)

5. An information display device which is mounted on a moving body that receives power supply from a battery to travel by a motor drive, and which operates by receiving the power supply from the battery, the display device comprising:
a display screen; and
a display controller that performs control to switch the display screen to either a normal display or an economy display in which consumption of the battery is reduced as compared with the normal display in accordance with a travel mode of the moving body and a display content on the display screen,
wherein the display controller switches the screen to the normal display if the moving body is traveling in a normal travel mode, and switches the screen to the normal display if the moving body is traveling in an economy travel mode in which the consumption of the battery is reduced as compared with the normal travel mode.

6. The information display device according to claim 5, wherein the display controller switches the screen to the economy display irrespective of the travel mode of the moving body if a remaining value of the battery is input, and the remaining value of the battery is a predetermined value or less.

7. An information display device which is mounted on a moving body that receives power supply from an engine drive or a battery to travel by a motor drive, and which operates by receiving the power supply from the battery, the display device comprising:
a display screen; and
a display controller that performs control to switch the display screen to either a normal display or an economy display in which consumption of the battery is reduced as compared with the normal display in accordance with a travel mode of the moving body and a display content on the display screen,
wherein the display controller switches the screen to the normal display if the moving body is traveling in a hybrid travel mode by the engine drive and the battery drive, and switches the screen to the economy display if the moving body is traveling in an electric travel mode by only the battery drive.

8. The information display device according to claim 7, wherein the display controller switches the screen to the economy display irrespective of the travel mode of the moving body if a remaining value of the battery is input, and the remaining value of the battery is a predetermined value or less.

9. The information display device according to claim 5, further comprising a navigation function that displays a map and a current position of the moving body on the display screen,
wherein the display controller switches the screen to the economy display in which a width in a vertical direction of a display range of the display screen is reduced if the current position is moving in a horizontal direction on the display screen.

10. The information display device according to claim 5, further comprising a navigation function that displays a map and a current position of the moving body on the display screen,
wherein the display controller switches the screen to the economy display in which a width in a horizontal direction of a display range of the display screen is reduced if the current position is moving in a vertical direction on the display screen.

11. The information display device according to claim 5, further comprising: a navigation function that displays a map and a current position of the moving body on the display screen; and a video display function that displays a video on the display screen,
wherein the display controller switches the screen to the economy display in which either a width in a horizontal direction of a display range of the display screen or a width in a vertical direction thereof is reduced if the navigation function is being performed, and switches the screen to the economy display in which the display range of the display screen is reduced while an aspect ratio of the display range is maintained.

12. The information display device according to claim 7, further comprising a navigation function that displays a map and a current position of the moving body on the display screen,
wherein the display controller switches the screen to the economy display in which a width in a vertical direction of a display range of the display screen is reduced if the current position is moving in a horizontal direction on the display screen.

13. The information display device according to claim 7, further comprising a navigation function that displays a map and a current position of the moving body on the display screen,
wherein the display controller switches the screen to the economy display in which a width in a horizontal direction of a display range of the display screen is reduced if the current position is moving in a vertical direction on the display screen.

14. The information display device according to claim 7, further comprising: a navigation function that displays a map and a current position of the moving body on the display screen; and a video display function that displays a video on the display screen,
wherein the display controller switches the screen to the economy display in which either a width in a horizontal direction of a display range of the display screen or a width in a vertical direction thereof is reduced if the navigation function is being performed, and switches the screen to the economy display in which the display range of the display screen is reduced while an aspect ratio of the display range is maintained.
